(19) United States
(12) Patent Application Publication
(10) Pub. No.: US 2025/0316201 A1
(43) Pub. Date: Oct. 9, 2025

(54) ENHANCED CONTENT PROCESSING

(71) Applicant: RAKUTEN KOBO INC., Toronto (CA)

(72) Inventors: Ramesh MANTHA, Toronto (CA); Steve LI, Richmond Hills (CA)

(73) Assignee: RAKUTEN KOBO INC., Toronto, ON (CA)

(21) Appl. No.: 19/169,900

(22) Filed: Apr. 3, 2025

Related U.S. Application Data
(60) Provisional application No. 63/573,909, filed on Apr. 3, 2024.

(51) Int. Cl. G09G 3/20

(52) U.S. Cl. CPC G09G 3/2003; G09G 2320/0666

(57) ABSTRACT

A device may include a light source configured to emit light associated with a first light spectrum and a display configured to reflect the light, as reflected light associated with a first reflected light spectrum, to visually present digital content in a color associated with a second light spectrum. The device may include circuitry configured to determine whether the first light spectrum differs from the second light spectrum. The circuitry may be configured to modify, based on reflectance properties of the display and based on the first light spectrum differing from the second light spectrum, the first reflected light spectrum to create a modified reflected light spectrum representative of the color. The circuitry may be configured to cause the display to render, based on the modified reflected light spectrum, the digital content in the color that is associated with the second light spectrum.

### CROSS-REFERENCE TO RELATED APPLICATION

This application claims the benefit of U.S. Provisional Application No. 63/573,909, filed Apr. 3, 2024, which is incorporated herein by reference in its entirety.

### BACKGROUND

An electronic device may be used to visually present information, such as digital content, on a display for user interaction and consumption. For example, the information may include text, images, and/or multimedia, which may be rendered for display.

### SUMMARY

Some implementations described herein relate to a device, comprising: a light source configured to emit light associated with a first light spectrum; a display configured to reflect the light, as reflected light associated with a first reflected light spectrum, to visually present digital content, wherein the display is associated with reflectance properties, and wherein a color of the digital content is associated with a second light spectrum which is different from the first light spectrum; and circuitry configured to: determine whether the first light spectrum differs from the second light spectrum; modify, based on the reflectance properties and the first light spectrum differing from the second light spectrum, the first reflected light spectrum to create a modified reflected light spectrum representative of the color; and cause the display to render, based on the modified reflected light spectrum, the digital content in the color that is associated with the second light spectrum.

Some implementations described herein relate to a method, comprising: determining, by a device, whether a first light spectrum of light, to be emitted by a light source of the device, differs from a second light spectrum, wherein a display of the device is configured to reflect the light, as reflected light associated with a first reflected light spectrum, to visually present digital content, wherein a color of the digital content is associated with a second light spectrum which is different from the first light spectrum, and wherein the display is associated with reflectance properties; modifying, based on the reflectance properties and the first light spectrum differing from the second light spectrum, the first reflected light spectrum to create a modified reflected light spectrum representative of the color; and causing the display to render, based on the modified reflected light spectrum, the digital content in the color that is associated with the second light spectrum.

Some implementations described herein relate to a non-transitory computer-readable medium storing a set of instructions, the set of instructions comprising: one or more instructions that, when executed by one or more processors of a device, cause the device to: determine whether a first light spectrum of light, to be emitted by a light source of the device, differs from a second light spectrum, wherein the second light spectrum is representative of a color of digital content, wherein a display of the device is configured to reflect the light as reflected light associated with a first reflected light spectrum, and wherein the display is associated with reflectance properties; modify, based on the reflectance properties and the first light spectrum differing from the second light spectrum, the first reflected light spectrum to create a modified reflected light spectrum representative of the color; and cause the display to render, based on the modified reflected light spectrum, the digital content in the color.

### BRIEF DESCRIPTION OF THE DRAWINGS

FIGS. 1A-1C are diagrams of an example associated with enhanced content processing.

FIG. 2 is a diagram of example components of a device associated with enhanced content processing.

FIG. 3 is a flowchart of an example process associated with enhanced content processing.

### DETAILED DESCRIPTION OF EXAMPLE EMBODIMENTS

The following detailed description of example implementations refers to the accompanying drawings. The same reference numbers in different drawings may identify the same or similar elements.

An electronic device may be used to visually present digital content, such as color digital content. However, typical electronic devices cannot accurately reproduce colors of the digital content, such as when lighting conditions of light used to visually present the digital content (e.g., a light source of the electronic device used to illuminate a reflective color display of the electronic device) differ from lighting conditions used to define the colors of the digital content.

In some cases, an electronic device may include a color adjustable light source. However, if a color of the light emitted by the color adjustable light source is different from a color of light used to define an intended color of digital content, such as an image, a perceived color of the image (e.g., as viewed by a user of the electronic device) will be different from the intended color.

Some implementations described herein enable an electronic device, having a variable color front light and a reflective display, to render digital content such that a displayed color matches an original color of the digital content regardless of a current color of light being emitted by the variable color front light. To accomplish this, and for example, the electronic device may change a pixel reflection spectrum to account for relative differences based on a color of the light emitted by the variable color front light and a color of light used to define the original color, as described in more detail elsewhere herein.

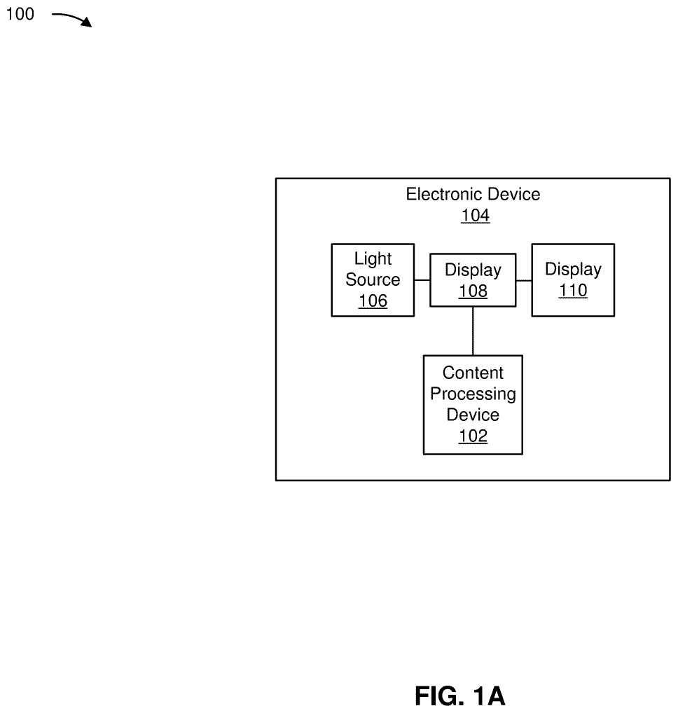

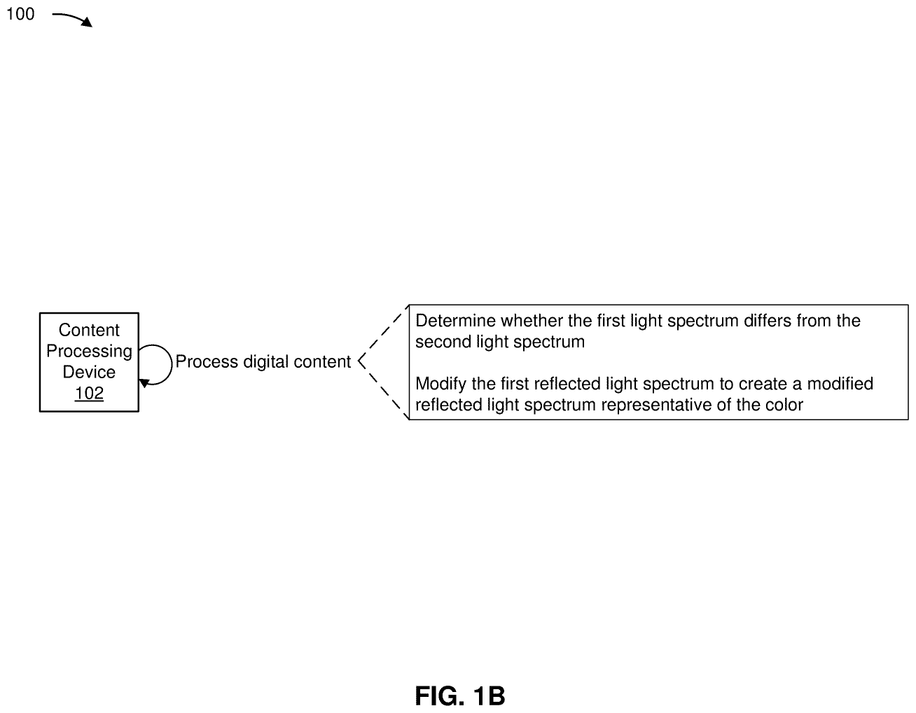

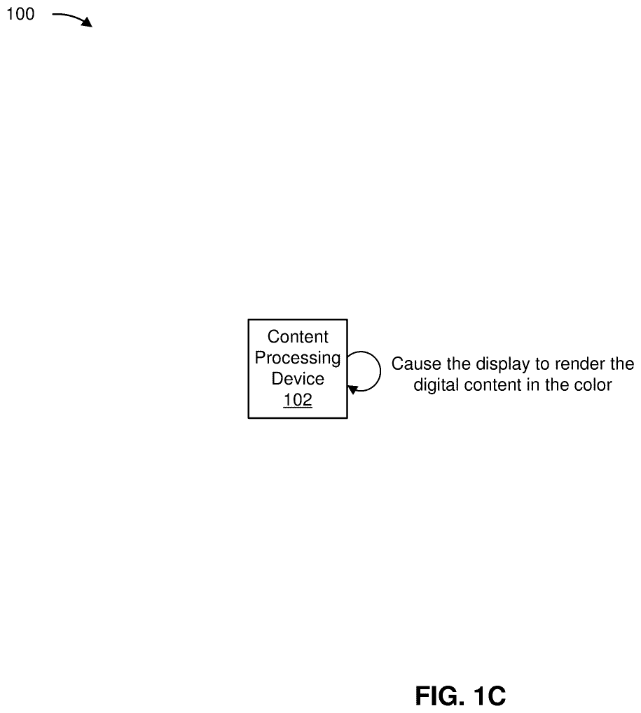

FIGS. 1A-1C are diagrams of an example 100 associated with enhanced content processing. As shown in FIG. 1A, the example 100 includes a content processing device 102. In some implementations, the content processing device 102 may be configured to process content, such as color and/or non-color (e.g., a black color, a white color, and/or a gray color) digital content (e.g., images, videos, text-based content, two-dimensional (2D) data, three-dimensional (3D) data, interactive content, and/or mixed reality content, among other examples), associated with an electronic device.

Accordingly, and in some implementations, the content processing device 102 may be part of an electronic device (e.g., an electronic device 104, as shown in FIG. 1A, including a light source 106, a display 108, and the content processing device 102). For example, the content processing device 102 may be implemented as circuitry within the electronic device 104.

Although the content processing device 102 is described as being part of the electronic device 104, in some implementations, the content processing device 102 may be separate from the electronic device 104. For example, the content processing device 102 may be implemented as a server device communicably coupled to the electronic device 104, among other examples.

In some implementations, the light source 106 may be an adjustable light source capable of emitting light with varying spectral properties. For example, spectral properties may be associated with characteristics of light that define a composition of the light across different wavelengths. For example, the spectral properties may include a light spectrum, a spectral power distribution, and/or a color temperature (e.g., associated with light emitted, or to be emitted by, the light source 106), among other examples.

The spectral properties of light emitted by the light source 106 may influence how the emitted light interacts with the display 108 (e.g., affecting visual representation and/or color perception of digital content presented via the display 108), as described in more detail elsewhere herein. In some implementations, the content processing device 102 may be configured to control spectral properties of light emitted, or to be emitted, by the light source 106, such as by adjusting a setting of the light source 106.

In some implementations, light spectra (e.g., of light emitted, or to be emitted, by the light source 106) may be associated with lighting conditions. For example, lighting conditions may correspond to color temperatures that define a composition of wavelengths within a light spectrum, among other examples. The content processing device 102 may be configured to control a color temperature of the light emitted by the light source 106 and/or may perform one or more actions based on the color temperature of the light emitted by the light source 106, as described in more detail elsewhere herein.

In some implementations, the light source 106 may be a front light and the display may be a reflective display (e.g., a reflective color display). For example, the front light may be a color temperature adjustable front light, a red-green-blue (RGB) adjustable front light, a single-color white light-emitting diode (LED) front light, and/or a tunable multi-spectrum front light, among other examples. The front light may be configured to direct light toward the reflective display (e.g., the front light may be positioned to direct light through a light guide layer to illuminate the display without emitting light directly from the pixels).

As another example, the reflective display may be a reflective color display with configurable display elements or pixels, among other examples. Accordingly, and in some implementations, the front light may be configured to emit light (e.g., associated with a first light spectrum) toward the display 108, and the display 108 may be configured to reflect the light, as reflected light associated with a first reflected light spectrum, to visually present digital content.

In some implementations, the display 108 may be associated with reflectance properties. For example, reflectance properties may be associated with characteristics of a surface that determine how the surface reflects incident light (e.g., the emitted by the light source 106). As an example, the reflectance properties may include a reflectance percentage (e.g., associated with a proportion of light reflected versus absorbed), a wavelength-dependent reflectance (e.g., associated with how different wavelengths are reflected at varying intensities), and/or a surface texture (e.g., which may influence scattering of the light), among other examples.

Accordingly, in some implementations, the reflected light spectrum (e.g., produced by the display 108) may result from an interaction between the light associated with the first light spectrum (e.g., emitted by the light source 106) and the reflectance properties of the display 108. As a result, an observable color (e.g., a visible color or a perceived color) of digital content visually presented by the display 108 may be influenced by both the color temperature of the light emitted by the light source 106 and the reflectance properties of the display 108, as described in more detail elsewhere herein.

As shown in FIG. 1B, the content processing device 102 may be configured to process digital content. In some implementations, the digital content may be associated with a color and/or a non-color. For example, the digital content may be an image including colored pixels (e.g., red pixels, blue pixels, and/or green pixels, among other examples) and non-colored pixels (e.g., black pixels, white pixels, and/or grey pixels, among other examples).

In some implementations, the light source 106 may be configured to emit light associated with a first light spectrum (e.g., a first color temperature). The display 108 may be configured to reflect the light (e.g., emitted by the light source 106), as reflected light associated with a first reflected light spectrum (e.g., based on the first light spectrum and the reflectance properties of the display 108), to visually present the digital content.

In some implementations, the color of the digital content may be associated with a second light spectrum which is different form the first light spectrum. For example, the color of the digital content may be represented by a representation, such as color coordinates (e.g., CIE coordinates) that define the color (e.g., a chromaticity) within a color space (e.g., a CIE color space), among other examples. In some implementations, the color represented by the coordinates may be defined within the color space based on using a light source associated with a reference light spectrum (e.g., associated with a color temperature of 6500 Kelvin (K), among other examples). Accordingly, and for example, the second light spectrum may correspond to the reference light spectrum.

The content processing device 102 may be configured to determine color coordinates that represent the color of the digital content. For example, the content processing device 102 may determine color coordinates (e.g., for individual pixels) that define (e.g., collectively define) the color of the digital content.

Based on the color coordinates, the content processing device 102 may cause the display 108 to render the digital content in the color. However, if the first light spectrum (e.g., emitted by the light source 106) is different from the second light spectrum (e.g., the reference light spectrum), the digital content may be visually presented by the display 108 in an inaccurate color (e.g., the observable color of the digital content may appear different from the color defined by the color coordinates).

For example, and if the first light spectrum has a warmer color temperature relative to a color temperature of 6500K (e.g., a warmer color temperature of 2000K), the observable color may shift toward red and yellow hues. As another example, and if the first light spectrum has a cooler color temperature relative to a color temperature of 6500K (e.g., a cooler color temperature of 8000K), the observable color may shift toward blue hues.

In some implementations, the content processing device 102 may be configured to perform enhanced content (e.g., digital content) processing to visually present the digital content in the color (e.g., an accurate color represented by the color coordinates), as described in more detail elsewhere herein.

As further shown in FIG. 1B, the content processing device 102 may be configured to determine whether the first light spectrum differs from the second light spectrum. For example, the content processing device 102 may be configured to determine a setting (e.g., a current setting) of the light source 106. For example, the content processing device 102 may be configured to determine a color temperature modulation (CTM) setting (e.g., a current CTM setting) to determine a color temperature of the first spectrum and a color temperature of the second light spectrum may be a reference color temperature (e.g., 6500K).

Accordingly, and in some implementations, the content processing device 102 may determine that the first light spectrum differs from the second light spectrum based on the color temperature of the first light spectrum differing from the color temperature of the second light spectrum. In other words, the content processing device 102 may be configured to analyze the CTM setting of the light source 106 to determine whether a color temperature (e.g., of light emitted, or to be emitted, by the light source 106) deviates from a reference color temperature (e.g., 6500K).

As further shown in FIG. 1B, the content processing device 102 may be configured to modify, based on the reflectance properties (e.g., of the display 108) and differences between the first light spectrum and the second light spectrum, the first reflected light spectrum to create a modified reflected light spectrum representative of the color. For example, the modified reflected light spectrum may be derived based on a comparison of the reflectance properties, the first light spectrum and the second light spectrum (e.g., a relative difference between how the reflectance properties interact with the first light spectrum and how the reflectance properties interact with the second light spectrum).

In some implementations, the relative difference between how the reflectance properties interact with the first light spectrum and how the reflectance properties interact with the second light spectrum may correspond to a shift between the color of the digital content, as represented by the color coordinates, and the color of the digital content that may be, or is to be, visually presented on the display 108. In other words, and in some implementations, the content processing device 102 may be configured to accurately reproduce the color of the digital content visually presented on the display by applying a correction based on a reflected light spectrum/reflective ratio.

In some implementations, the content processing device 102 may determine a modifier (e.g., spectral characteristic values, among other examples) based on the relative difference between how the reflectance properties interact with the first light spectrum and how they interact with the second light spectrum. For example, the modifier may account for the shift between the color of the digital content, as represented by the color coordinates, and the color of the digital content that may be, or is to be, visually presented on the display 108. The content processing device 102 may modify, using the modifier, the reflected light spectrum to create the modified reflected light spectrum. In this way, the modified reflected light spectrum accurately represents the color of the digital content.

In some implementations, the content processing device 102 may determine, based on the modified reflected light spectrum, subsequent color coordinates which correspond to the color coordinates representing the color. The content processing device 102 may visually present the digital content in the color (e.g., which corresponds to the color represented by the color coordinates), based on the subsequent color coordinates, as described in more detail elsewhere herein.

As shown in FIG. 1C, the content processing device 102 may be configured to cause the display 108 to render the digital content in the color (e.g., which corresponds to the color defined by the color coordinates). For example, the content processing device 102 may be configured to render, based on at least one of the modified reflected light spectrum or the subsequent color coordinates, the digital content in the color (e.g., which corresponds to the color represented by the color coordinates). In this way, some implementations described herein enable accurate reproduction of color (e.g., of digital content) under varying lighting conditions (e.g., color temperatures deviating from 6500K, among other examples).

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

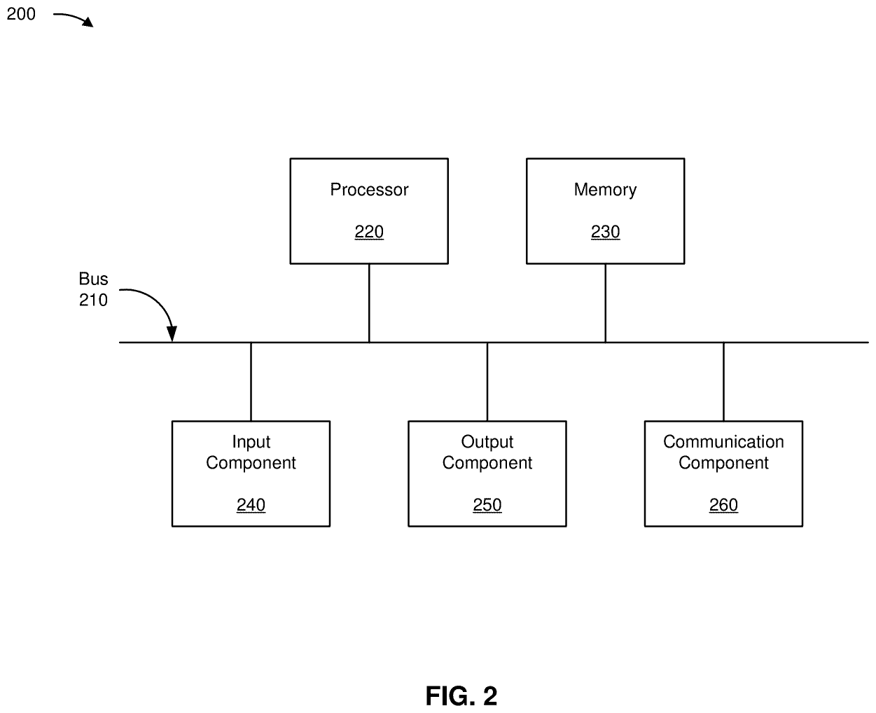

FIG. 2 is a diagram of example components of a device 200 associated with enhanced content processing. The device 200 may correspond to the content processing device 102, the electronic device 104, the light source 106, and/or the display 108. In some implementations, the content processing device 102, the electronic device 104, the light source 106, and/or the display 108 may include one or more of the devices 200 and/or one or more components of the device 200. As shown in FIG. 2, the device 200 may include a bus 210, a processor 220, a memory 230, an input component 240, an output component 250, and/or a communication component 260.

The bus 210 may include one or more components that enable wired and/or wireless communication among the components of the device 200. The bus 210 may couple together two or more components of FIG. 2, such as via operative coupling, communicative coupling, electronic coupling, and/or electric coupling. For example, the bus 210 may include an electrical connection (e.g., a wire, a trace, and/or a lead) and/or a wireless bus. The processor 220 may include a central processing unit, a graphics processing unit, a microprocessor, a controller, a microcontroller, a digital signal processor, a field-programmable gate array, an application-specific integrated circuit, and/or another type of processing component. The processor 220 may be implemented in hardware, software, and/or a combination of hardware and software. In some implementations, the processor 220 may include one or more processors capable of being programmed to perform one or more operations or processes described elsewhere herein.

The memory 230 may include volatile and/or nonvolatile memory. For example, the memory 230 may include random access memory (RAM), read only memory (ROM), a hard disk drive, and/or another type of memory (e.g., a flash memory, a magnetic memory, and/or an optical memory). The memory 230 may include internal memory (e.g., RAM, ROM, or a hard disk drive) and/or removable memory (e.g., removable via a universal serial bus connection). The memory 230 may be a non-transitory computer-readable medium. The memory 230 may store information, one or more instructions, and/or software (e.g., one or more software applications) related to the operation of the device 200. In some implementations, the memory 230 may include one or more memories that are coupled (e.g., communicatively coupled) to one or more processors, such as via the bus 210. Communicative coupling between the processor 220 and the memory 230 may enable the processor 220 to read and/or process information stored in the memory 230 and/or to store information in the memory 230.

The input component 240 may enable the device 200 to receive input, such as user input and/or sensed input. For example, the input component 240 may include a touch screen, a keyboard, a keypad, a mouse, a button, a microphone, a switch, a sensor, a global positioning system sensor, an accelerometer, a gyroscope, and/or an actuator. The output component 250 may enable the device 200 to provide output, such as via a display, a speaker, and/or a light-emitting diode. The communication component 260 may enable the device 200 to communicate with other devices via a wired connection and/or a wireless connection. For example, the communication component 260 may include a receiver, a transmitter, a transceiver, a modem, a network interface card, and/or an antenna.

The device 200 may perform one or more operations or processes described herein. For example, a non-transitory computer-readable medium (e.g., memory 230) may store a set of instructions (e.g., one or more instructions or code) for execution by the processor 220. The processor 220 may execute the set of instructions to perform one or more operations or processes described herein. In some implementations, execution of the set of instructions, by one or more processors, causes the one or more processors and/or the device 200 to perform one or more operations or processes described herein. In some implementations, hardwired circuitry may be used instead of or in combination with the instructions to perform one or more operations or processes described herein. Additionally, or alternatively, the processor 220 may be configured to perform one or more operations or processes described herein. Thus, implementations described herein are not limited to any specific combination of hardware circuitry and software.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

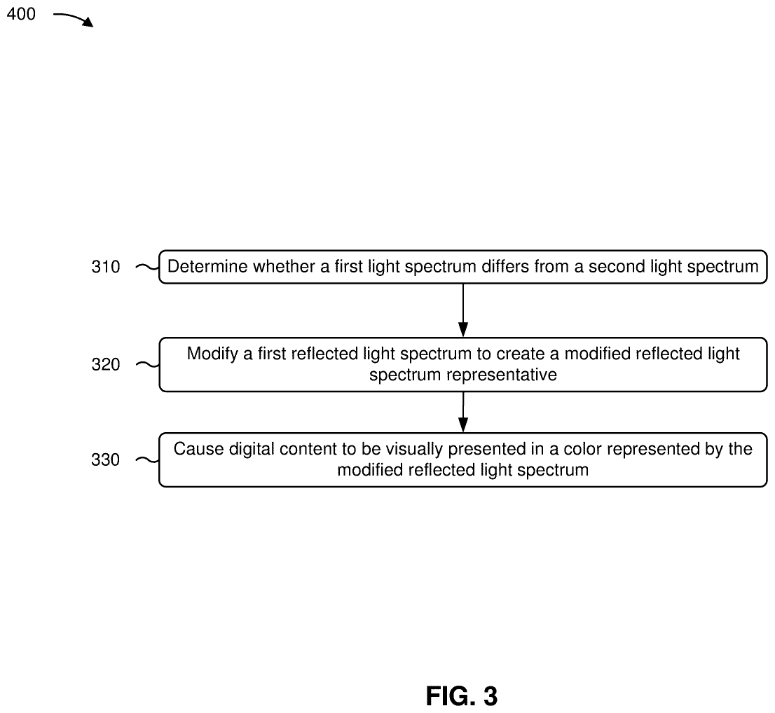

FIG. 3 is a flowchart of an example process 300 associated with enhanced content processing. In some implementations, one or more process blocks of FIG. 3 may be performed by a content processing device (e.g., the content processing device 102). In some implementations, one or more process blocks of FIG. 3 may be performed by another device or a group of devices separate from or including the content processing device, such as an electronic device (e.g., the electronic device 104) and/or one or more components of an electronic device (e.g., the light source 106 and/or the display 108 of the electronic device 104). Additionally, or alternatively, one or more process blocks of FIG. 3 may be performed by one or more components of the device 200, such as the processor 220, the memory 230, the input component 240, the output component 250, and/or the communication component 260.

As shown in FIG. 3, the process 300 may include determining whether a first light spectrum differs from a second light spectrum (block 310). For example, the content processing device may determine whether a first light spectrum of light, to be emitted by the light source of the electronic device, differs from a second light spectrum (e.g., the reference light spectrum), as described in more detail elsewhere herein.

In some implementations, the display of the electronic device may be configured to reflect the light, as reflected light associated with a first reflected light spectrum, to visually present digital content. A color of the digital content may be associated with the second light spectrum. The display may be associated with reflectance properties.

As further shown in FIG. 3, the process 300 may include modifying a first reflected light spectrum to create a modified reflected light spectrum representative (block 320). For example, the content processing device may modify, based on the reflectance properties and the first light spectrum differing from the second light spectrum, the first reflected light spectrum to create a modified reflected light spectrum representative of the color, as described in more detail elsewhere herein.

As further shown in FIG. 3, the process 300 may include causing digital content to be visually presented (e.g., rendered) in a color represented by the modified reflected light spectrum (block 330). For example, the content processing device may cause the display to render, based on the modified reflected light spectrum, the digital content in the color (e.g., an accurate color), as described in more detail elsewhere herein.

In some implementations, the process 300 may include causing (e.g., by the content processing device) the light source to emit the light associated with the first light spectrum toward the display after the modified reflected light spectrum is created. In some implementations, the process 300 may include determining (e.g., by the content processing device), based on the modified reflected light spectrum, color coordinates corresponding to the color, and causing the display to render, based on the color coordinates, the digital content in the color.

In some implementations, the light source may be configured to be adjustable (e.g., emit the light having the first light spectrum and the first light spectrum may be selected from multiple light spectra). In some implementations, the multiple light spectra may be associated with different lighting conditions. For example, the different lighting conditions may correspond to different color temperatures, among other examples.

In some implementations, the second light spectrum may correspond to a reference light spectrum (e.g., such as light source with a color temperature of 6500K), as described in more detail elsewhere herein. In some implementations, the digital content may include non-color digital content (e.g., black digital content, white digital content, and/or grey digital content), and process 300 may include refraining (e.g., by the content processing device), from modifying a portion of the first reflected light spectrum corresponding to the non-color digital content. In other words, and in some implementations, the process 300 may include correcting only color portions of the digital content for accurate visual representation.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

As used herein, the term “component” is intended to be broadly construed as hardware, software, and/or a combination of hardware and software. It will be apparent that systems and/or methods described herein may be implemented in different forms of hardware, software, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Additionally, the functionality of the elements described herein may be implemented using circuitry or processing circuitry, including general-purpose processors, special-purpose processors, ICs, ASICs, conventional circuitry, or combinations thereof, configured or programmed to perform the disclosed functionality. A processor is a type of processing circuitry, as it includes transistors and other physical circuit components. A processor may execute instructions stored in a memory, thereby operating as a programmed processor. In this disclosure, the terms “circuitry,” “units,” or “means” refer to hardware that performs, or is programmed to perform, the described functionality. Such hardware may include any disclosed hardware or other known hardware that is configured or programmed to execute the described functions. When the hardware includes a processor, which is a type of circuitry, the circuitry, means, or units refer to a combination of hardware and software, where the software configures the hardware and/or processor to perform the specified functions.

To the extent the aforementioned implementations collect, store, or employ personal

information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”' a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A device, comprising:
a light source configured to emit light associated with a first light spectrum;
a display configured to reflect the light, as reflected light associated with a first reflected light spectrum, to visually present digital content,
wherein the display is associated with reflectance properties, and
wherein a color of the digital content is associated with a second light spectrum which is different from the first light spectrum; and
circuitry configured to:
determine whether the first light spectrum differs from the second light spectrum;
modify, based on the reflectance properties and the first light spectrum differing from the second light spectrum, the first reflected light spectrum to create a modified reflected light spectrum representative of the color; and
cause the display to render, based on the modified reflected light spectrum, the digital content in the color that is associated with the second light spectrum.

2. The device of claim 1, wherein the circuitry is configured to determine whether the first light spectrum differs from the second light spectrum before the light source emits the light associated with the first light spectrum.

3. The device of claim 1, wherein the circuitry, to cause the display to render, based on the modified reflected light spectrum, the digital content in the color, is configured to:
determine, based on the modified reflected light spectrum, color coordinates corresponding to the color; and
cause the display to render, based on the color coordinates, the digital content in the color.

4. The device of claim 1, wherein the light source is adjustable to emit the light having the first light spectrum, and
wherein the first light spectrum is selected from multiple light spectra.

5. The device of claim 1, wherein the first light spectrum is associated with a lighting condition.

6. The device of claim 1, wherein the second light spectrum corresponds to a reference light spectrum.

7. The device of claim 1, wherein the digital content includes non-color digital content, and
wherein the circuitry is configured to:
refrain from modifying a portion of the first reflected light spectrum corresponding to the non-color digital content.

8. A method, comprising:
determining, by a device, whether a first light spectrum of light, to be emitted by a light source of the device, differs from a second light spectrum,
wherein a display of the device is configured to reflect the light, as reflected light associated with a first reflected light spectrum, to visually present digital content,
wherein a color of the digital content is associated with a second light spectrum which is different from the first light spectrum, and
wherein the display is associated with reflectance properties;
modifying, based on the reflectance properties and the first light spectrum differing from the second light spectrum, the first reflected light spectrum to create a modified reflected light spectrum representative of the color; and
causing the display to render, based on the modified reflected light spectrum, the digital content in the color that is associated with the second light spectrum.

9. The method of claim 8, wherein causing the display to render, based on the modified reflected light spectrum, the digital content in the color comprises:
causing the light source to emit the light associated with the first light spectrum toward the display after the modified reflected light spectrum is created.

10. The method of claim 8, wherein causing the display to render, based on the modified reflected light spectrum, the digital content in the color comprises:
determining, based on the modified reflected light spectrum, color coordinates corresponding to the color; and
causing the display to render, based on the color coordinates, the digital content in the color.

11. The method of claim 8, wherein the light source is adjustable to emit the light having the first light spectrum, and
wherein the first light spectrum is selected from multiple light spectra.

12. The method of claim 8, wherein the first light spectrum is associated with a lighting condition.

13. The method of claim 8, wherein the second light spectrum corresponds to a reference light spectrum.

14. The method of claim 8, wherein the digital content includes non-color digital content, and
wherein the method further comprises:
refraining, by the device, from modifying a portion of the first reflected light spectrum corresponding to the non-color digital content.

15. A non-transitory computer-readable medium storing a set of instructions, the set of instructions comprising:
one or more instructions that, when executed by one or more processors of a device, cause the device to:
determine whether a first light spectrum of light, to be emitted by a light source of the device, differs from a second light spectrum,
wherein the second light spectrum is representative of a color of digital content,
wherein a display of the device is configured to reflect the light as reflected light associated with a first reflected light spectrum, and
wherein the display is associated with reflectance properties;
modify, based on the reflectance properties and the first light spectrum differing from the second light spectrum, the first reflected light spectrum to create a modified reflected light spectrum representative of the color; and
cause the display to render, based on the modified reflected light spectrum, the digital content in the color that is associated with the second light spectrum.

16. The non-transitory computer-readable medium of claim 15, wherein the one or more instructions that, when executed by the one or more processors of the device, cause the display to render, based on the modified reflected light spectrum, the digital content in the color, cause the device to:
cause the light source to emit the light associated with the first light spectrum toward the display after the modified reflected light spectrum is created.

17. The non-transitory computer-readable medium of claim 15, wherein the one or more instructions that, when executed by the one or more processors of the device, cause the display to render, based on the modified reflected light spectrum, the digital content in the color, cause the device to:
cause the light source to emit the light associated with the first light spectrum toward the display after the modified reflected light spectrum is created.

18. The non-transitory computer-readable medium of claim 15, wherein the light source is adjustable to emit the light having the first light spectrum, and wherein the first light spectrum is selected from multiple light spectra.

19. The non-transitory computer-readable medium of claim 15, wherein the first light spectrum is associated with a lighting condition.

20. The non-transitory computer-readable medium of claim 15, wherein the second light spectrum corresponds to a reference light spectrum.
